(19) United States
(12) Patent Application Publication
(10) Pub. No.: US 2022/0196424 A1
(43) Pub. Date: Jun. 23, 2022

(54) VEHICLE CONTROL METHOD AND VEHICLE CONTROL DEVICE

(71) Applicant: HITACHI ASTEMO, LTD., Hitachinaka-shi, Ibaraki (JP)

(72) Inventors: Keisuke TAKEUCHI, Ibaraki (JP); Tomoyasu SAKAGUCHI, Ibaraki (JP); Masashi SEIMIYA, Ibaraki (JP)

(73) Assignee: HITACHI ASTEMO, LTD., Hitachinaka-shi, Ibaraki (JP)

(21) Appl. No.: 17/611,333

(22) PCT Filed: Aug. 14, 2020
(86) PCT No.: PCT/JP2020/030841

§ 371 Date: Nov. 15, 2021

(30) Foreign Application Priority Data
Aug. 20, 2019 (JP) 2019-150517

(51) Int. Cl. G01C 21/34; G01C 21/36; B60W 60/00; B60W 40/105

(52) U.S. Cl. CPC G01C 21/3484; G01C 21/3617; B60W 2420/42; B60W 40/105; B60W 2554/4049; B60W 60/001

(57) ABSTRACT

When a vehicle is caused to autonomously travel and is guided to a target point, if an error from a design value occurs in a position or dimensions of an external-environment sensor due to a secular change of the vehicle, a riding state, or a loading state, an error also occurs in a sensing result. Thus, positional accuracy at the target point is deteriorated. There is provided a vehicle control method of controlling a vehicle by a vehicle control device including a processor and a memory. The vehicle control method includes a step of storing route information up to a predetermined point by the vehicle control device, and a step of performing autonomous traveling based on the route information by the vehicle control device. In the step of storing, a section for collecting information for disturbance correction on an external-environment sensor is stored. In the step of performing the autonomous traveling, the disturbance correction on the external-environment sensor is performed using information collected during traveling in the section.

### TECHNICAL FIELD

The present invention relates to a vehicle control method and a vehicle control device for supporting driving of an automobile.

### BACKGROUND ART

In the related art, there has been known a vehicle control device that stores a route on which a host vehicle travels, and surrounding environment information on an object or a white line around the host vehicle and then controls the vehicle by using the stored surrounding environment information, in order to realize an autonomous driving system or a parking assistance system of a vehicle (see PTL 1, for example).

In automatic parking, as compared with autonomous traveling on a general road, a vehicle is guided in a narrower space such as in a parking frame line or between other vehicles or objects, and thus higher accuracy is also required for external recognition. As an external-environment sensor for recognizing the external world, a camera and a distance measuring sensor are adopted.

In particular, when a vehicle is stopped in the parking frame on which the frame line is drawn, since it is not possible to recognize the frame line by an ultrasonic sensor, the frame line is detected from an image captured by the camera, by an image recognition technology, and the stop position is calculated.

In steering control and acceleration/deceleration control in automatic parking, it is necessary to detect the position of the host vehicle position with high accuracy, but it is not possible to obtain necessary accuracy with a global positioning system (GPS) widely used for host vehicle position measurement, and thus host vehicle position estimation using a wheel speed sensor is used (see PTL 2, for example).

### CITATION LIST

### Patent Literature

PTL 1: JP 2016-99635 A
PTL 2: International Publication No. 2018/173907

### SUMMARY OF INVENTION

### Technical Problem

In an external-environment sensor for automatic parking as described above, an error from a design value occurs in a position and dimensions due to a secular change of the vehicle, a riding state of an occupant, or a loading state of luggage.

Specifically, in the case of the camera, an error occurs in a relative position and an orientation direction from a reference point on a vehicle. In the case of the wheel speed sensor, an error occurs in a tire circumferential length.

If the error remains, an error also occurs in the sensing result. Thus, in the case of automatic parking, it is not possible to stop the vehicle at a desired stop position with high accuracy. Since the error varies for each trip, it is desirable to correct the error before starting automatic parking every time.

Therefore, the present invention has been made in view of the above problems, and the object of the present invention is to suppress accumulation of errors with traveling after correction, by correcting an error of the external-environment sensor.

### Solution to Problem

According to the present invention, there is provided a vehicle control method of controlling a vehicle by a vehicle control device including a processor and a memory. The vehicle control method includes a step of storing route information up to a predetermined point by the vehicle control device, and a step of performing autonomous traveling based on the route information by the vehicle control device. In the step of storing, a section for collecting information for disturbance correction on an external-environment sensor is stored. In the step of performing the autonomous traveling, the disturbance correction on the external-environment sensor is performed using information collected during traveling in the section.

### Advantageous Effects of Invention

According to the present invention, it is possible to minimize the accumulation of errors with traveling after correction, by performing error correction of an external-environment sensor immediately before start of automatic parking. Thus, positional accuracy when the vehicle autonomously travels, and then stops at a parking start point is improved, and this contributes to improvement of the accuracy of the final parking position.

In addition, since information for correcting an error of the external-environment sensor while maintaining a vehicle speed and steering to predetermined values by autonomous traveling, correction information closer to ideal can be obtained as compared with a case where an occupant drives, and thus correction accuracy is improved.

Furthermore, by correcting an error of the external-environment sensor immediately before the start of automatic parking, it is possible to correct a state of the external-environment sensor under a condition closer to that at the time of performing automatic parking.

Details of at least one embodiment of the subject matter disclosed herein are set forth in the accompanying drawings and the following description. Other features, aspects, and effects of the disclosed subject matter will be apparent from the following disclosure, drawings, and claims.

### BRIEF DESCRIPTION OF DRAWINGS

FIG. 1 is a block diagram illustrating Embodiment 1 of the present invention and illustrating an example of functions of a driving assistance system.

FIG. 2 is a diagram illustrating Embodiment 1 of the present invention and an example of a configuration of a vehicle.

FIG. 3 is a plan view illustrating Embodiment 1 of the present invention and illustrating an example of a use form assumed by the driving assistance system.

FIG. 4 is a flowchart illustrating Embodiment 1 of the present invention and illustrating an example of processing in which a vehicle control device stores a traveling route and a route surrounding environment.

FIG. 5 is a plan view illustrating Embodiment 1 of the present invention and illustrating an example of processing of approximating a traveling route by the vehicle control device.

FIG. 6 is a flowchart illustrating Embodiment 1 of the present invention and illustrating an example of processing in which the vehicle control device extracts a section for collecting correction information.

FIG. 7 is a flowchart illustrating Embodiment 1 of the present invention and illustrating an example of autonomous traveling processing by the vehicle control device.

FIG. 8 is a flowchart illustrating Embodiment 1 of the present invention and illustrating processes from collection of correction information to correction processing by the vehicle control device.

FIG. 9A is a plan view illustrating Embodiment 1 of the present invention and illustrating a trajectory of feature points on a bird-eye view image when a position and an orientation direction of a camera have design values.

FIG. 9B is a plan view illustrating Embodiment 1 of the present invention and illustrating a trajectory of the feature points on the bird-eye view image when there is an error from the design values in the position and the orientation direction of the camera.

FIG. 9C is a plan view illustrating Embodiment 1 of the present invention and illustrating a trajectory of the feature points on the bird-eye view image when there is an error from the design values in the position and the orientation direction of the camera.

FIG. 9D is a plan view illustrating Embodiment 1 of the present invention and illustrating a trajectory of the feature points on the bird-eye view image when there is an error from the design values in the position and the orientation direction of the camera.

FIG. 9E is a plan view illustrating Embodiment 1 of the present invention and illustrating a trajectory of the feature points on the bird-eye view image when there is an error from the design values in the position and the orientation direction of the camera.

FIG. 10 is a flowchart illustrating Embodiment 2 of the present invention and illustrating an example of processing in which a vehicle control device extracts a section for collecting correction information.

FIG. 11 is a block diagram illustrating Embodiment 3 of the present invention and illustrating an example of functions of a driving assistance system.

FIG. 12 is a plan view illustrating Embodiment 4 of the present invention and illustrating an example of a vehicle passing through an ETC gate.

FIG. 13 is a flowchart illustrating Embodiment 4 of the present invention and illustrating an example of processing performed by a vehicle control device.

### DESCRIPTION OF EMBODIMENTS

Hereinafter, embodiments of the present invention will be described with reference to the drawings.

### Embodiment 1

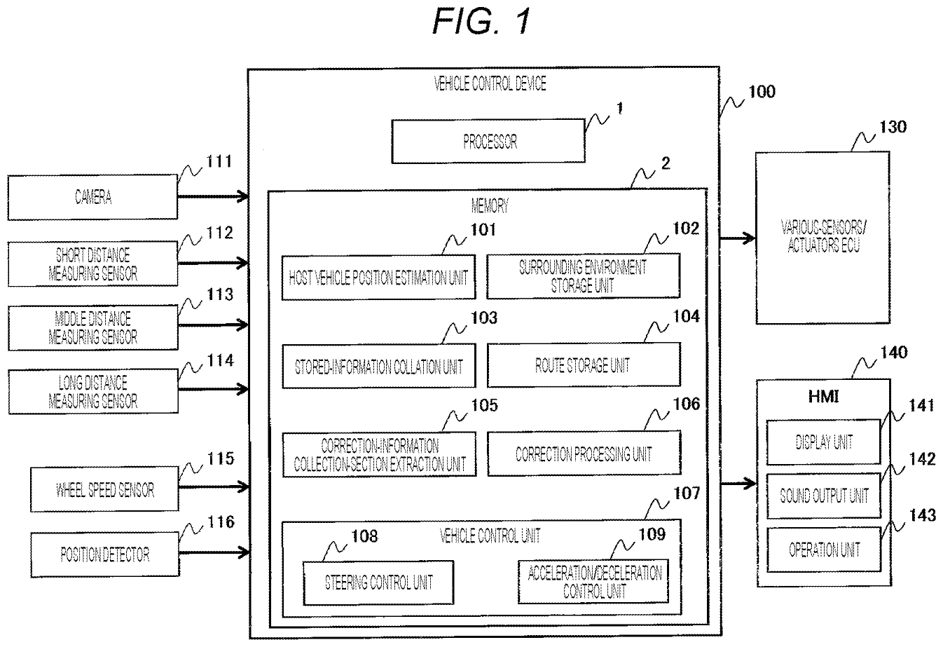

Embodiment 1 of the present invention will be described with reference to FIGS. 1 to 9.

In Embodiment 1, in a driving assistance system that performs autonomous traveling including parking by using a traveling route stored in advance, information for correcting an error in a position and an orientation direction of a camera is automatically acquired during the autonomous traveling, and correction processing is executed.

FIG. 1 is a block diagram illustrating an example of functions of a driving assistance system according to Embodiment 1 of the present invention. A vehicle control device 100 includes a camera 111, a short distance measuring sensor 112, a middle distance measuring sensor 113, a long distance measuring sensor 114, a wheel speed sensor 115, a position detector 116, a various-sensors/actuators ECU 130 of a vehicle, and a human machine interface (HMI) 140.

The vehicle control device 100 includes a processor 1 and a memory 2. In the vehicle control device 100, the respective programs of a host vehicle position estimation unit 101, a surrounding environment storage unit 102, a stored-information collation unit 103, a route storage unit 104, a correction-information collection-section extraction unit 105, a correction processing unit 106, and a vehicle control unit 107 are loaded into the memory 2 and executed by the processor 1.

The processor 1 executes processing in accordance with a program of each functional unit to run as the functional unit that provides a predetermined function. For example, the processor 1 executes processing in accordance with a host vehicle position estimation program to function as the host vehicle position estimation unit 101. The same applies to other programs. Further, the processor 1 also runs as a functional unit that provides each function in a plurality of pieces of processing executed by the respective programs. A computer and a computer system are a device and a system including such functional units.

The host vehicle position estimation unit 101 calculates the position of a host vehicle (vehicle 200) by using information output from the position detector 116 and the wheel speed sensor 115.

The surrounding environment storage unit 102 uses the camera 111, the short distance measuring sensor 112, the middle distance measuring sensor 113, and the long distance measuring sensor 114 to store surrounding environment information acquired when the vehicle travels by a driving operation of an occupant.

In the present embodiment, the camera 111, the short distance measuring sensor 112, the middle distance measuring sensor 113, and the long distance measuring sensor 114 function as external-environment sensors. The surrounding environment information includes three-dimensional object information on a utility pole, a sign, a traffic light, and the like and road surface information on a white line of a road surface, a crack, unevenness of a road surface, and the like.

The stored-information collation unit 103 collates the information of the surrounding environment detected by the external-environment sensors mounted on the vehicle 200 with the information stored in the surrounding environment storage unit 102, and determines whether or not the information of the detected surrounding environment coincides with the stored information.

When it is determined that surrounding environment information coincides with the stored information, the vehicle control device 100 transitions to an autonomous traveling possible state. When it is determined that the surrounding environment information does not coincide with the stored information, the vehicle control device 100 transitions to an autonomous traveling impossible state.

The route storage unit 104 generates and stores autonomous traveling route information from a traveling trajectory of the vehicle when the surrounding environment information is acquired.

The correction-information collection-section extraction unit 105 uses route information stored in the route storage unit 104 and the surrounding environment information stored in the surrounding environment storage unit 102 to extract a section in which information necessary for correcting an error of the camera 111 is collected.

The correction processing unit 106 calculates the error of the camera 111 by using correction information collected in the section extracted by the correction-information collection-section extraction unit 105, and determines necessity of correction. When it is determined that correction is necessary, the correction processing unit 106 calculates a correction amount and applies the correction amount to processing using an image from the camera 111 as an input.

The vehicle control unit 107 is configured by a steering control unit 108 and an acceleration/deceleration control unit 109. The vehicle control unit 107 calculates target values of steering and acceleration/deceleration when autonomous traveling is performed, and outputs a control instruction including the target values to the various-sensors/actuators ECU 130.

The camera 111 is used to capture an image of a target object having visual information that mainly has meaning, such as a white line, a road mark, or a sign around the vehicle. Image data obtained by the camera 111 is input to the vehicle control device 100.

The short distance measuring sensor 112 is used to detect an object in a range up to about several meters around the vehicle, and is configured by sonar as an example. The sonar transmits an ultrasonic wave toward the surroundings of the host vehicle and receives the reflected wave. In this manner, the sonar detects a distance to the object near the host vehicle.

Distance measurement data by the short distance measuring sensor 112 is input to the vehicle control device 100.

The middle distance measuring sensor 113 is used to detect an object in a range up to about several tens of meters in front of and behind the vehicle, and is configured by a millimeter wave radar as an example. The millimeter wave radar transmits a high-frequency wave called a millimeter wave toward the surroundings of the host vehicle and receives the reflected wave. In this manner, the millimeter wave radar detects the distance to the object. Distance measurement data by the middle distance measuring sensor 113 is input to the vehicle control device 100.

The long distance measuring sensor 114 is used to detect an object in a range up to about 200 m in front of the vehicle, and is configured by a millimeter wave radar, a stereo camera, or the like as an example.

Distance measurement data by the long distance measuring sensor 114 is input to the vehicle control device 100.

The wheel speed sensor 115 includes a pulse counter and a controller. The pulse counter is attached to each wheel of the vehicle 200 and counts a pulse signal generated by rotation of the wheel. The controller generates a vehicle speed signal by integrating values detected by the pulse counters. Vehicle speed signal data from the wheel speed sensor 115 is input to the vehicle control device 100.

The position detector 116 includes an azimuth sensor that measures an azimuth in front of the host vehicle and a receiver of a signal of a global navigation satellite system (GNSS) that measures the position of the vehicle based on a radio wave from a satellite.

The various-sensors/actuators ECU 130 operates a traveling power source, a transmission, a brake device, and the like in accordance with an instruction from the vehicle control device 100.

The HMI 140 is configured by a display device 141, a sound output unit 142, and an operation unit 143. An occupant performs setting regarding driving assistance and issues instruction of start and end of driving assistance via the operation unit 143. The HMI 140 receives notification information to the occupant, from other components, and thus displays the contents on the display device 141 in a form of words or picture symbols, or performs report as a warning sound or sound guidance from the sound output unit 142.

As the operation unit 143, a form using a physical switch disposed near a driver seat, a form of performing an operation by touching a button displayed on the display device 141 configured by a touch panel with a finger, or the like is considered. The present invention does not limit the form.

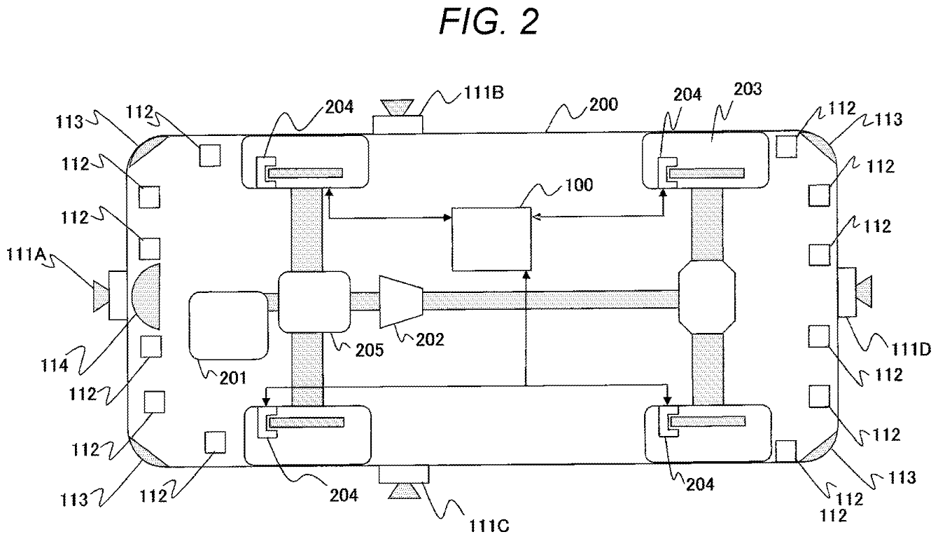

FIG. 2 illustrates an example of a configuration of a vehicle in Embodiment 1 of the present invention. The illustrated vehicle 200 includes a traveling power source 201, a transmission 202, four wheels 203, a brake device 204 including the wheel speed sensor, and a power steering device 205.

An actuator and an ECU that operate the above-described components are connected to the vehicle control device 100 via an in-vehicle network such as a controller area network (CAN).

The vehicle control device 100 obtains information outside the vehicle 200 from the external-environment sensor, and transmits command values for realizing control such as automatic parking and autonomous driving to the various-sensors/actuators ECU 130. The various-sensors/actuators ECU 130 operates the traveling power source 201, the brake device 204, the power steering device 205, and the transmission 202 in accordance with the command values.

In the vehicle 200, a front camera 111A is attached to a front end, side cameras 111B and 111C are attached to left and right side surfaces, and a rear camera 111D is attached to a rear end.

The vehicle control device 100 can synthesize a bird-eye view image in which the vehicle 200 and the surroundings thereof are looked down from above, by projection-converting and combining the images captured by the four cameras 111A to 111D. The bird-eye view image is used when being displayed on the display device 141.

Further, in the vehicle 200, the short distance measuring sensor 112 is attached to the front end, the rear end, and the side surface, the middle distance measuring sensor 113 is attached to the front end and the rear end, and the long distance measuring sensor 114 is attached to the front portion. The mounting positions and the number thereof are not limited to the contents illustrated in FIG. 2.

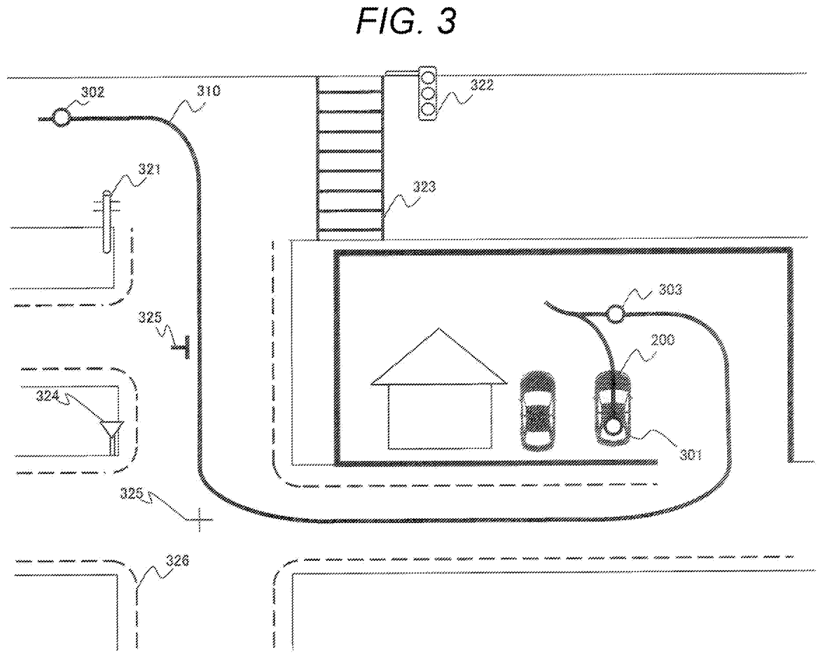

A use form assumed by the driving assistance system in Embodiment 1 of the present invention will be described with reference to FIG. 3. FIG. 3 illustrates a plan view in which the vehicle 200 having the present system travels through a route used on a daily basis to a storage location and then stops at a target parking position 301.

When an occupant is driving the vehicle 200, if the occupant issues an instruction to start storing of the surrounding environment information at a storing start point 302, the vehicle control device 100 stores a subsequent traveling route 310 of the vehicle 200 and the surrounding environment information of the traveling route 310.

In addition, when the occupant starts parking by a driving operation of the occupant, if the occupant issues an instruction to store a parking start point 303, the vehicle control device 100 stores the position of the parking start point 303.

When the vehicle 200 travels to the target parking position 301 through the same traveling route 310 next in a state where the storing of the information is completed, if the vehicle 200 reaches the storing start point 302, the vehicle control device 100 notifies the occupant that autonomous traveling is possible.

Here, if the occupant issues an instruction to start the autonomous traveling, the vehicle control device 100 controls the steering and the vehicle speed, so that the vehicle 200 performs the autonomous traveling while tracking the stored traveling route 310.

Further, when the vehicle 200 reaches the parking start point 303 by the autonomous traveling, the vehicle automatically stops.

Here, after the occupant gets off the vehicle and the inside of the vehicle 200 becomes unmanned, if the occupant issues an instruction to start parking by remote control from the outside of the vehicle, the vehicle 200 automatically performs parking while tracking the stored traveling route 310. If the vehicle reaches a target parking position 301, the autonomous traveling is ended.

Here, processing of storing the traveling route and the route surrounding environment will be described.

When the vehicle 200 is traveling by the driving operation of the occupant, if the occupant performs a predetermined operation on the operation unit 143, the vehicle control device 100 starts to store the traveling route and the route surrounding environment.

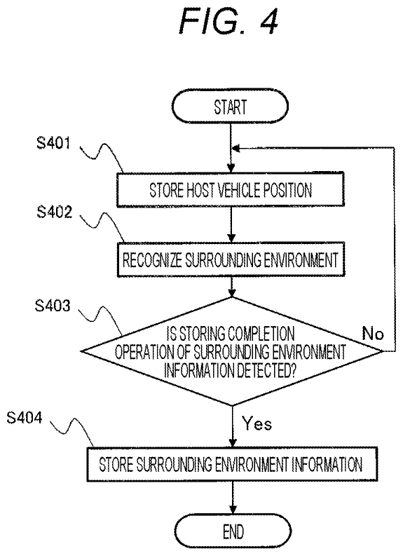

FIG. 4 is a flowchart illustrating an example of processing executed by the vehicle control device 100 when the vehicle 200 stores the surrounding environment information while traveling by driving of the occupant.

When storing the surrounding environment information is started by the occupant, the vehicle control device 100 acquires and stores the host vehicle position (Step S401). Specifically, the vehicle control device 100 calculates a rough position of the vehicle 200 by using GNSS information of the position detector 116.

Then, the vehicle control device 100 recognizes the surrounding environment of the vehicle 200 by inputs from the camera 111, the short distance measuring sensor 112, the middle distance measuring sensor 113, and the long distance measuring sensor 114, and acquires position information of the recognized information (Step S402). Specifically, in FIG. 3, a recognition target is a stationary object in three-dimensional object information or road surface information, such as a utility pole 321, a traffic light 322, a pedestrian crossing 323, a sign 324, a road mark 325, and a white line 326 present beside the road. The stationary objects are set as the surrounding environment information.

For the road mark 325 in the surrounding environment information acquired in Step S402, a pattern from which the feature point can be extracted by the correction processing unit 106 is registered in advance, and, when the road mark coincides with the pattern, identification information indicating that the road mark is a reference road mark is added.

Then, the vehicle control device 100 determines whether or not the occupant has performed an operation to end storing of the surrounding environment information (Step S403). Specifically, a predetermined operation by the operation unit 143, a shift operation to a P range, an operation of a parking brake, or the like is detected. When the operation to end the storing of the surrounding environment information is not detected, the process returns to Step S401 and the above-described processing is repeated.

When Step S401 is executed below, the position information of the vehicle 200 can be acquired not only by the GNSS but also by dead reckoning in which the movement distance and the yaw angle are calculated using the wheel pulse. When dead reckoning is used, the host vehicle position is given by coordinate values with the storing start point 302 as an origin.

When the operation to end the storing of the surrounding environment information is detected in Step S403, the vehicle control device 100 stores the recognized surrounding environment information in the surrounding environment storage unit 102 (Step S404). At this time, the vehicle control device 100 transforms the position information of the surrounding object expressed by coordinates relative to the host vehicle, into an absolute coordinate system. Here, for example, it is conceivable that the absolute coordinate system has the storing start point 302 as the origin or has the target parking position 301 as the origin, but the absolute coordinate system is not necessarily limited thereto.

When the above processing is completed, the vehicle control device 100 displays a message or the like in which the surrounding environment information is stored on the display device 141. The position of the vehicle 200 at which a shift operation to the P range, an operation of the parking brake, or the like is detected may be set as the target parking position 301, or the target parking position 301 may be designated by the operation unit 143.

In this manner, the vehicle control device 100 obtains the traveling trajectory of the vehicle 200 in the section from the position information of the vehicle 200 acquired during traveling by a driving operation of the occupant. However, when all pieces of the position information are stored, the amount of data becomes enormous, and thus there is a possibility that it is not possible to record the information in the route storage unit 104.

Therefore, the route storage unit 104 performs processing of reducing the data amount of the position information.

The route storage unit 104 performs processing of approximating a section from the storing start point 302 to the parking start point 303 in the trajectory (traveling route 310) obtained from the host vehicle position information acquired in Step S401, by a combination of a straight section and a curved section.

The straight section obtained at this time is expressed by a start point and an end point, and the curved section is expressed by using an intermediate point added as necessary in addition to the start point and the end point.

The start point, the end point, and the intermediate point of each section are collectively referred to as a route point below.

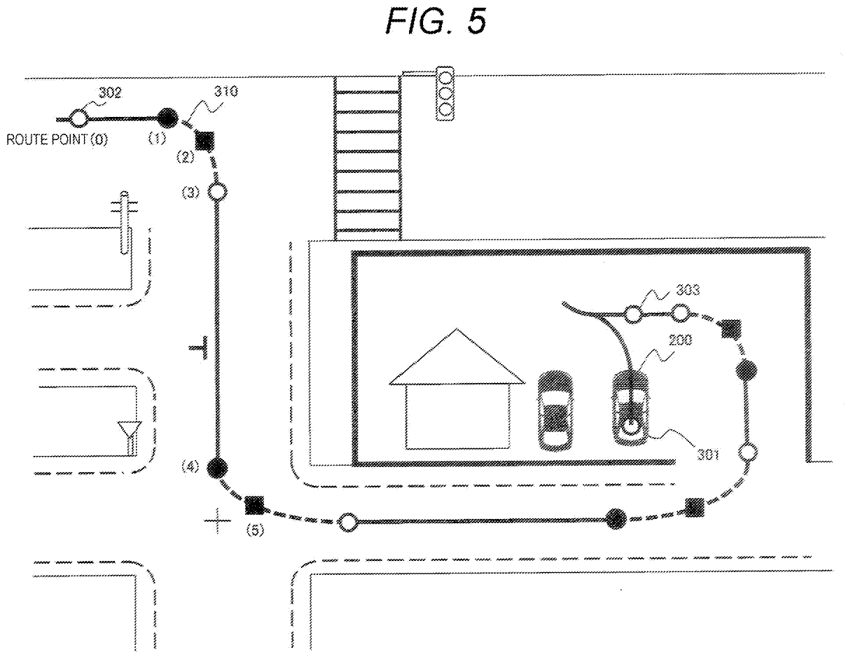

FIG. 5 illustrates an example in which processing of approximating the traveling route 310 in FIG. 3 by a combination of a straight section and a curved section is performed.

In the traveling route 310 in FIG. 5, a solid line indicates a straight section, and a dotted line indicates a curved section. In FIG. 5, a white circle indicates a start point of the straight section, a black circle indicates a start point of the curved section, and a black square indicates an intermediate point of the curved section. The end point of the straight section is the same as the start point of the subsequent curved section, and the end point of the curved section is the same as the start point of the subsequent straight section.

Then, the route storage unit 104 stores the information of the route point (start point or intermediate point) obtained by the above processing by setting a route storing start point as the 0th point, and then giving numbers in order of passing through the points. The i-th route point is referred to as a route point (i) below.

Here, the information of the route point includes at least coordinate values represented in the absolute coordinate system and an attribute value. The attribute value indicates which one of a start point of a straight section, an end point of the straight section, a start point of a curved section, an intermediate point of the curved section, and an end point of the curved section corresponds to the route point. In addition, when the route point corresponds to the final route point, that is, the parking start position, the information is also stored as the attribute value.

The steering control unit 108 refers to the above route information to generate a steering profile during autonomous traveling, and thus the vehicle performs straight traveling while maintaining a neutral steering angle in the straight section.

When the storing of the route information is completed in the vehicle control device 100, the correction-information collection-section extraction unit 105 extracts a section in which the correction information of the external-environment sensors is collected.

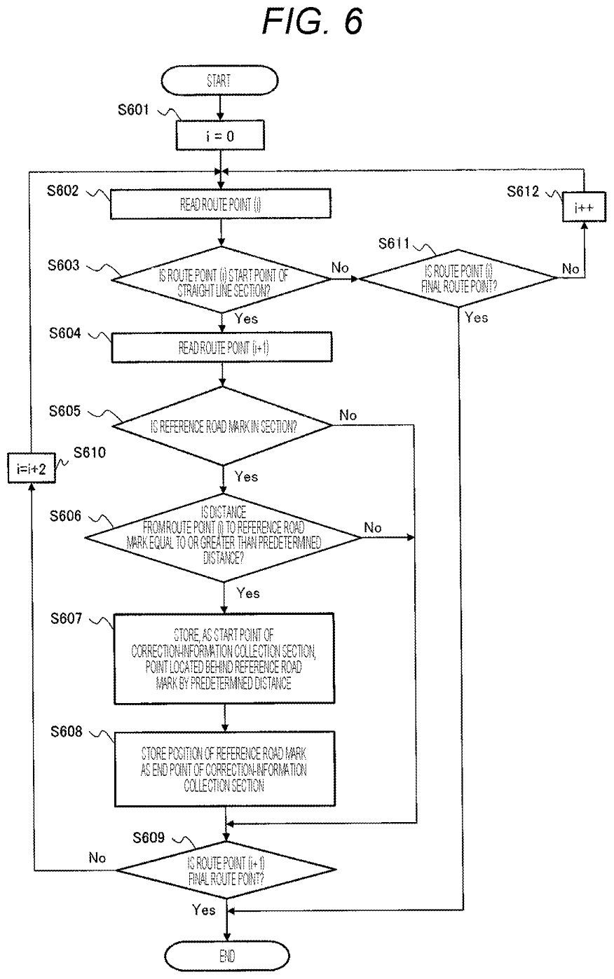

FIG. 6 is a flowchart illustrating an example of processing of the correction-information collection-section extraction unit 105. Such processing is executed before the autonomous traveling on the stored traveling route 310.

The correction-information collection-section extraction unit 105 sets the route point as i=0 (Step S601), refers to the information of the route point (i) stored in the route storage unit 104 (Step S602), and determines whether or not the route point (i) is the start point of the straight section (Step S603).

In Step S603, when the route point (i) is the start point of the straight section, the correction-information collection-section extraction unit 105 refers to the information of the route point (i+1) stored in the route storage unit 104 (Step S604). Here, the route point (i+1) is the end point of the straight section having the route point (i) as the start point.

Then, the correction-information collection-section extraction unit 105 refers to the surrounding environment information stored in the surrounding environment storage unit 102, and determines whether or not a reference road mark is in the section between the route point (i) and the route point (i+1) (Step S605).

In Step S605, when there is the road mark, the correction-information collection-section extraction unit 105 calculates the distance from the route point (i) to the road mark, and determines whether or not the value of the distance is greater than a predetermined distance (Step S606). Here, the predetermined distance is set to a visual field range of the front camera 111A in a vehicle front-rear direction.

In Step S605, when there is no road mark, the process proceeds to Step S609.

In Step S606, when the distance from the route point (i) to the road mark is greater than the predetermined distance, the correction-information collection-section extraction unit 105 stores a point located behind the road mark by the predetermined distance, in the route storage unit 104 as a start point of a correction-information collection section (Step S607). Then, the correction-information collection-section extraction unit 105 stores the position of the road mark in the route storage unit 104 as an end point of the correction-information collection section (Step S608).

Then, the correction-information collection-section extraction unit 105 determines whether or not the route point (i+1) is the final route point (Step S609).

When the route point (i+1) is the final route point, the correction-information collection-section extraction unit 105 ends the processing. When the route point (i+1) is not the final route point, the correction-information collection-section extraction unit 105 adds 2 to i (Step S610), and returns to Step S602 to repeat the above processing.

In Step S606, when the distance from the route point (i) to the road mark is smaller than the predetermined distance, the process proceeds to Step S609.

In Step S603, when the route point (i) is not the start point of the straight section, the correction-information collection-section extraction unit 105 determines whether or not the route point (i) is the final route point (Step S611).

When the route point (i) is the end point of an autonomous traveling route, the processing is ended. When the route point (i) is not the end point of an autonomous traveling route, 1 is added to i (Step S612). Then, the process returns to Step S602.

The acceleration/deceleration control unit 109 generates a vehicle speed profile storing a predetermined vehicle speed in the correction-information collection section set by the correction-information collection-section extraction unit 105. The processing of generating the vehicle speed profile may be executed at any time as long as the process can be completed before the start of the next autonomous traveling.

With the above processing, when detecting the reference road mark in the traveling route 310, the correction-information collection-section extraction unit 105 can store a position behind the reference road mark by a predetermined distance as a start point of a correction information collection section, and store the position of the reference road mark as an end point of the correction-information collection section.

FIG. 7 is a flowchart illustrating an example of processing executed by the vehicle control device 100 when the vehicle autonomously travels by using the stored surrounding environment information.

When the vehicle 200 is traveling by a driving operation of an occupant in a state where the surrounding environment information and the route information are stored, the vehicle control device 100 uses the GNSS information of the position detector 116 to acquire a rough position of the host vehicle (Step S701).

Then, the vehicle control device 100 compares the host vehicle position acquired in Step S701 with the position of the storing start point 302, and determines whether or not the vehicle 200 has approached the storing start point 302 (Step S702). When it is determined that the vehicle is not approaching the storing start point, the process returns to Step S701.

When it is determined in Step S702 that the vehicle has approached the storing start point, the vehicle control device 100 recognizes the surrounding environment (Step S703), and causes the stored-information collation unit 103 to execute processing of collation between the surrounding environment information stored in the surrounding environment storage unit 102 and the recognized surrounding environment (Step S704).

Specifically, it is determined whether or not the difference between the position of a target object such as an object or a white line recognized by the camera 111, the short distance measuring sensor 112, the middle distance measuring sensor 113, and the long distance measuring sensor 114 and the position of the target object stored in the surrounding environment storage unit 52 is equal to or smaller than a predetermined value.

In Step S704, when the stored-information collation unit 103 determines that the recognized surrounding environment information coincides with the information stored in the surrounding environment storage unit 102, the vehicle control device 100 transitions to a state where autonomous traveling is possible, and determines whether or not an autonomous traveling start operation is performed by the occupant (Step S705).

When the autonomous traveling start operation is not detected, the vehicle control device 100 determines whether or not the vehicle has traveled a predetermined distance or longer from the storage start position (Step S706). When the vehicle has traveled the predetermined distance or longer, the processing is ended. When the vehicle has not traveled the predetermined distance or longer, the process returns to Step S705.

When the autonomous traveling start operation is detected, the vehicle control device 100 performs steering and acceleration/deceleration control with the vehicle control unit 107 (Step S707) to performs autonomous traveling.

In addition, the vehicle control device 100 collects correction information for the camera 111 with the start of the autonomous traveling as a trigger, and determines the necessity of the correction. As a result, when it is determined that correction is necessary, correction processing is executed (Step S708). The detailed processing of Step S708 will be described later.

If Step S708 is ended, the vehicle control device 100 determines whether the vehicle 200 has reached the parking start point 303 (Step S709). When the vehicle has not reached the parking start point 303, the process returns to Step S707 and repeats the above processing.

When the vehicle has reached the parking start point 303, the HMI 140 waits for an operation of restarting the autonomous traveling by the operation unit 143 (Step S710).

The operation unit 143 is displayed on a terminal capable of remotely operating the vehicle 200 so as to be operable even when all occupants get off the vehicle 200.

When the operation of restarting the autonomous traveling is detected in Step S710, the vehicle control device 100 performs steering and acceleration/deceleration control with the vehicle control unit 107 (Step S711), and performs automatic parking.

At this time, since the errors in the position and orientation direction of the camera 111 are corrected, the recognition accuracy by the camera 111 is improved.

In addition, the vehicle control device 100 determines whether or not the vehicle has reached the target parking position 301 (Step S712). When it is determined that the vehicle has reached the target parking position 301, vehicle control device 100 ends the steering and acceleration/deceleration control (Step S713), and the process is completed.

Here, details of the processing in Step S708 will be described.

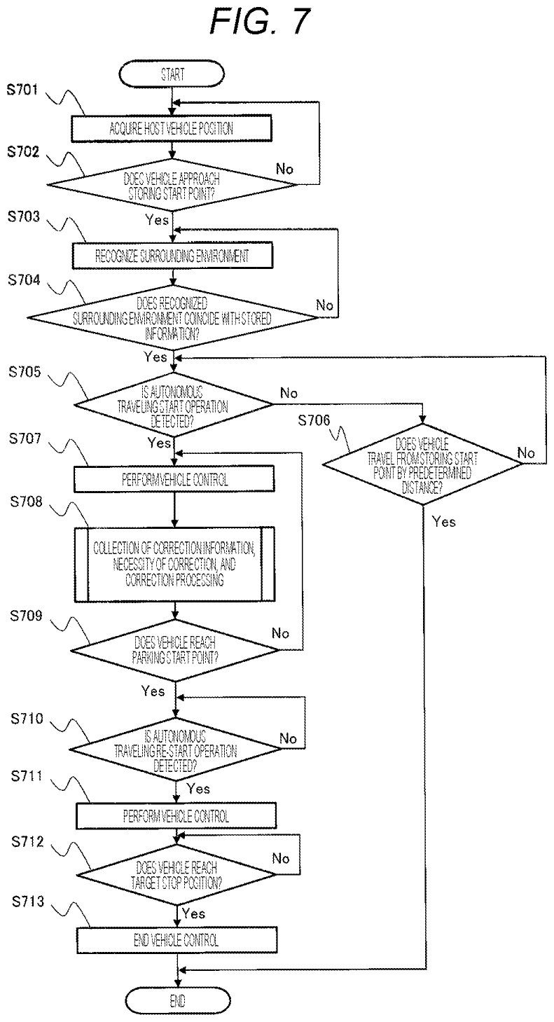

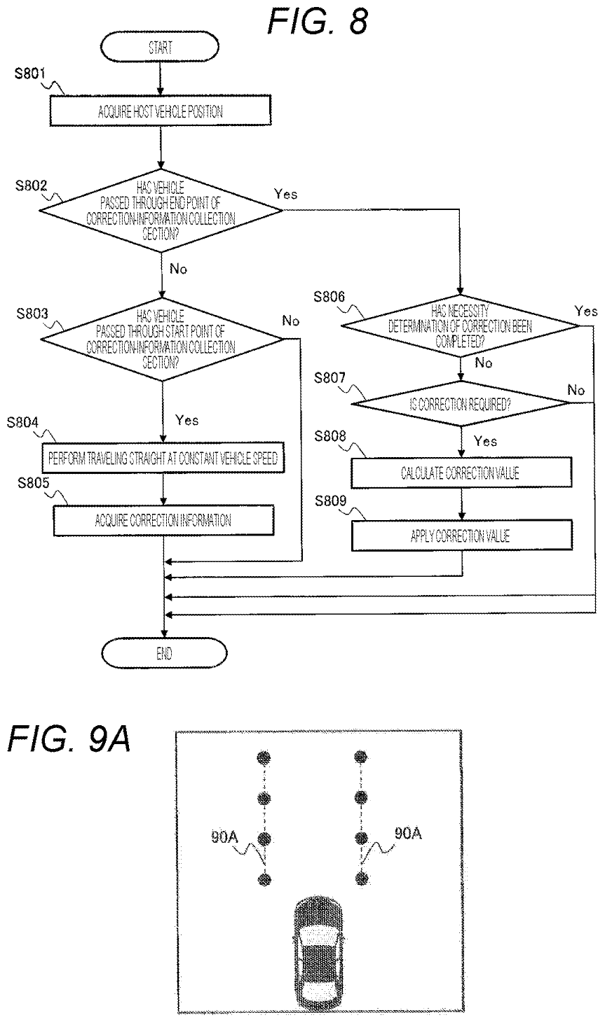

FIG. 8 is a flowchart illustrating detailed processing of Step S708 executed by the correction processing unit 106 of the vehicle control device 100.

The correction processing unit 106 in the vehicle control device 100 acquires host vehicle position information (Step S801), and determines whether or not the vehicle has passed through the end point of a correction-information collection section stored in the route storage unit 104 (Step S802).

When it is determined that the vehicle has not passed through the end point of the correction-information collection section, the vehicle control device 100 determines whether or not the vehicle has passed through the start point of the correction information collection section (Step S803).

When it is determined that the vehicle has passed through the start point of the correction-information collection section, the acceleration/deceleration control unit 109 performs acceleration/deceleration control to maintain a predetermined vehicle speed, in accordance with the vehicle speed profile generated after extraction of the correction information collection section (Step S804).

The correction processing unit 106 commands the acceleration/deceleration control unit 109 to move straight (the steering angle is neutral) at a vehicle speed set in advance, so as to obtain the optimum traveling condition for collecting the correction information.

Furthermore, the correction processing unit 106 stores images captured by the camera 111 (front camera 111A) as a correction image series (Step S805), and ends the processing of Step S708 in FIG. 7.

In a case where it is determined in Step S803 that the vehicle has not passed through the start point of the correction-information collection section, the vehicle control device 100 ends the processing of Step S708.

When it is determined in Step S802 that the vehicle has passed through the end point of the correction-information collection section, the vehicle control device 100 determines whether or not the necessity determination of the correction processing has been completed (Step S806). When it is determined that the necessity determination of the correction processing has not been completed, the correction processing unit 106 determines the necessity of the correction processing by using the stored correction image series (Step S807).

Specifically, a plurality of feature points are detected from the road mark shown in each frame of the correction image series, and the trajectory thereof are projected on a bird-eye view image.

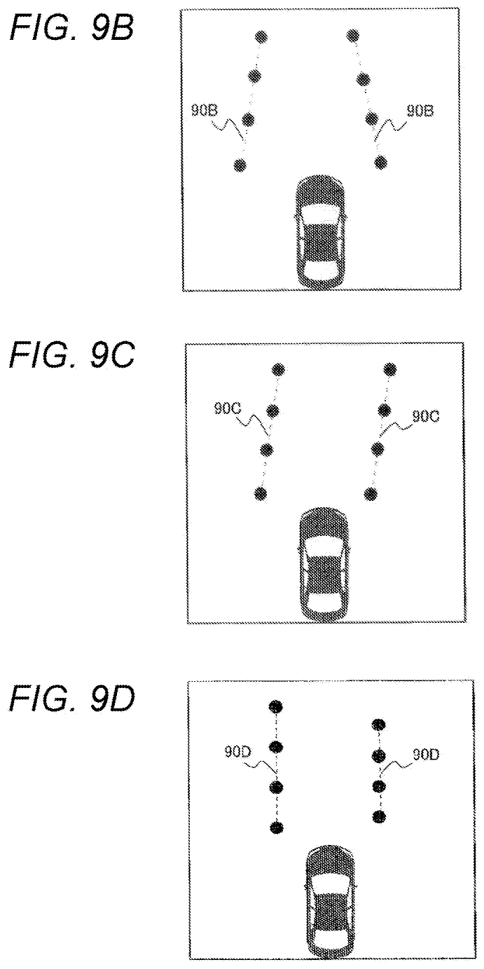

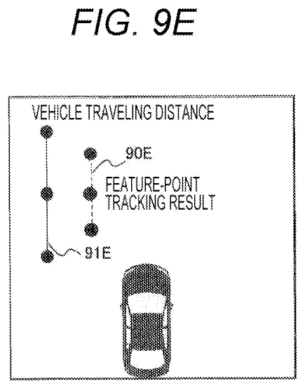

FIGS. 9A to 9E schematically illustrate the trajectories of feature points on the bird-eye view image when there is an error from the design value in the position and orientation direction of the camera.

When the vehicle 200 travels straight and the position and orientation direction of the front camera 111A are in an ideal state as designed, trajectories 90A of all the feature points on the bird-eye view image become straight lines parallel to a traveling direction of the vehicle 200 as illustrated in FIG. 9A.

On the other hand, when a pitch angle is generated in a vehicle body, trajectories 90B of the plurality of feature points are not parallel to the traveling direction of the vehicle 200, as illustrated in FIG. 9B.

When a yaw angle is generated in the vehicle body, trajectories 90C of the feature points are not parallel to the traveling direction of the vehicle 200 as illustrated in FIG. 9C.

When a roll angle is generated in the vehicle body, the lengths of trajectories 90D of the plurality of feature points are not equal to each other, as illustrated in FIG. 9D.

When a deviation in a height direction occurs due to sinking of the vehicle body or the like, as illustrated in FIG. 9E, the length of a feature point tracking result 90E does not coincide with a traveling distance 91E of the vehicle.

Therefore, the correction processing unit 106 calculates the difference between the trajectory 90A of the feature point in the ideal state and the trajectory of the feature point obtained from the actually captured image. When the difference is equal to or smaller than a threshold value, the correction processing unit 106 determines that the error is within an allowable value, and determines that the correction processing is unnecessary.

The correction processing unit 106 calculates the difference between the trajectory 90A of the feature point in the ideal state and the trajectory of the feature point obtained from the actually captured image. When the difference exceeds the threshold value, the correction processing unit 106 determines that the error exceeds the allowable value, and determines that the correction processing is necessary.

When it is determined in Step S807 that the correction processing is necessary, the correction processing unit 106 estimates the deviation amount in the position and the orientation direction of the camera such that the trajectory of the feature point in the ideal state is obtained from the captured correction image (Step S808). Then, the correction processing unit 106 applies the obtained value to image recognition processing (Step S809).

When it is determined in Step S807 that the correction process is unnecessary, the vehicle control device 100 ends the processing of Step S708.

When it is determined in Step S806 that the necessity determination of the correction processing has been completed, the vehicle control device 100 ends the processing of Step S708.

According to Embodiment 1 of the present invention, immediately before the start of automatic parking, the error in the position and orientation direction of the front camera 111A is corrected by using the correction information acquired while performing autonomous traveling. Thus, the recognition accuracy by the camera during automatic parking is improved, and the accuracy of the parking position can be improved.

In Example 1 described above, an example in which the correction processing is executed for the front camera 111A has been described, but similar processing can be executed for the side cameras 111B and 111C and the rear camera 111D.

### Embodiment 2

Embodiment 2 of the present invention will be described below.

In Embodiment 2, in a driving assistance system that performs autonomous traveling including parking by using a traveling route 310 stored in advance, information for correcting an error in a circumferential length of a tire (wheel 203) is automatically acquired during the autonomous traveling, and correction processing based on the method disclosed in PTL 2 is executed.

A configuration of the driving assistance system in Embodiment 2 of the present invention is the same as that in Embodiment 1, but the processing of the correction-information collection-section extraction unit 105 and the correction processing unit 106 is different from that in Embodiment 1.

Hereinafter, the same components and processing as those in Embodiment 1 are denoted by the same reference signs as those in Embodiment 1, and the detailed description thereof will be omitted.

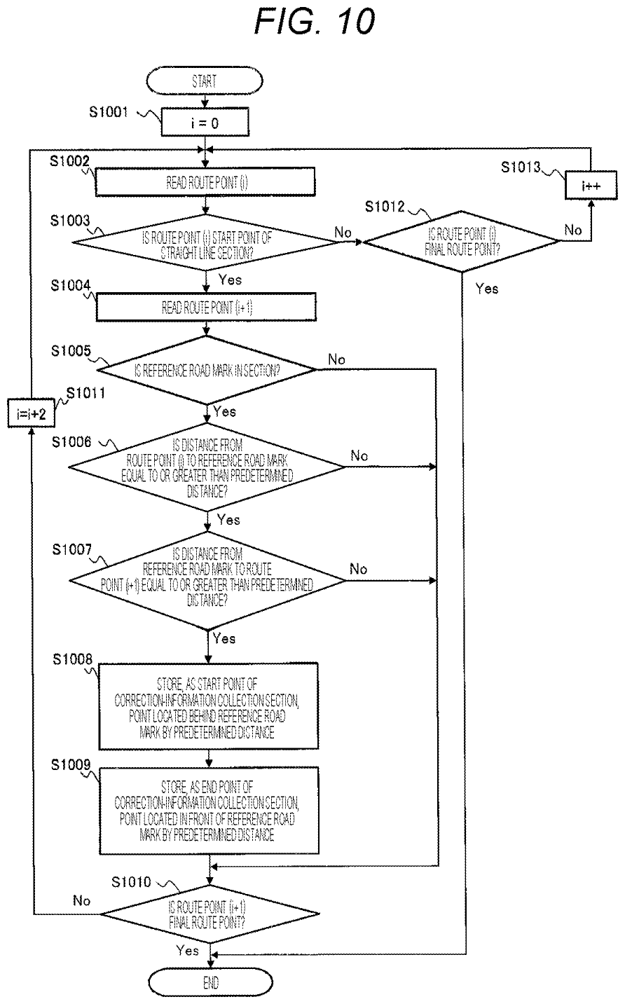

FIG. 10 is a flowchart illustrating an example of processing of the correction-information collection-section extraction unit 105 in Embodiment 2 of the present invention.

The correction-information collection-section extraction unit 105 sets the route point as i=0 (Step S1001), refers to the information of the route point (i) stored in the route storage unit 104 (Step S1002), and determines whether or not the route point (i) is the start point of the straight section (Step S1003).

In Step S1003, when the route point (i) is the start point of the straight section, the correction-information collection-section extraction unit 105 refers to the information of the route point (i+1) stored in the route storage unit 104 (Step S1004). Here, the route point (i+1) is the end point of the straight section having the route point (i) as the start point.

Then, the correction-information collection-section extraction unit 105 refers to the surrounding environment information stored in the surrounding environment storage unit 102, and determines whether or not a reference road mark is in the section between the route point (i) and the route point (i+1) (Step S1005).

In Step S1005, when there is the road mark, the correction-information collection-section extraction unit 105 calculates the distance from the route point (i) to the road mark, and determines whether or not the value of the distance is greater than a predetermined distance (Step S1006). Here, the predetermined distance is set as a vehicle overall length.

In Step S1005, when there is no road mark, the process proceeds to Step S1010.

In Step S1006, when the distance from the route point (i) to the road mark is greater than the predetermined distance, the correction-information collection-section extraction unit 105 calculates the distance from the road mark to the route point (i+1) and determines whether or not the value is greater than a predetermined distance (Step S1007).

In Step S1006, when the distance from the route point (i) to the road mark is smaller than the predetermined distance, the process proceeds to Step S1010.

In Step S1007, when the distance from the road mark to the route point (i+1) is greater than the predetermined distance, the correction-information collection-section extraction unit 105 stores a point located behind the road mark by the predetermined distance, in the route storage unit 104 as a start point of a correction-information collection section (Step S1008). Then, the correction-information collection-section extraction unit 105 stores a point located in front of the road mark by the predetermined distance, in the route storage unit 104 as an end point of a correction-information collection section (Step S1009).

Then, the correction-information collection-section extraction unit 105 determines whether or not the route point (i+1) is the final route point (Step S1010).

When the route point (i+1) is the final route point, the correction-information collection-section extraction unit 105 ends the processing. When the route point (i+1) is not the final route point, the correction-information collection-section extraction unit 105 adds 2 to i (Step S1011), and returns to Step S1002.

In Step S1007, when the distance from the road mark to the route point (i+1) is smaller than the predetermined distance, the process proceeds to Step S1010.

In Step S1003, when the route point (i) is not the start point of the straight section, the correction-information collection-section extraction unit 105 determines whether or not the route point (i) is the final route point (Step S1012).

When the route point (i) is the end point of an autonomous traveling route, the processing is ended. When the route point (i) is not the end point of an autonomous traveling route, 1 is added to i (Step S1013). Then, the process returns to Step S1002 to repeat the above processing.

Next, processing of the correction processing unit 106 in Embodiment 2 of the present invention will be described.

The processing of the correction processing unit 106 is as illustrated in the flowchart of FIG. 8, but the content of the correction information acquired in Step S805 and the specific contents of the correction processing after Step S807 are different from those in Embodiment 1.

In Step S805, the correction processing unit 106 stores images captured by the front camera 111A and the rear camera 111D and a wheel speed pulse count value at a time point of image capturing, as correction information.

In Step S807, the correction processing unit 106 detects a feature point from a road mark shown in the image of the front camera 111A and the image of the rear camera 111D in each frame in the correction information, and calculates the relative position to the vehicle 200.

When the road mark including the feature point is shown in a plurality of frames of the image of the front camera 111A or the image of the rear camera 111D, the image having the closest relative position to the vehicle 200 is selected.

The correction processing unit 106 calculates the distance at which the vehicle moves between the captured image of the front camera 111A and the captured image of the rear camera 111D by using the relative position and the overall length of the host vehicle, which are calculated above. If such a value is divided by the difference between the wheel speed pulse count values at the time point of capturing the image of the front camera 111A and the image of the rear camera 111D, the movement distance per pulse count can be calculated.

According to Embodiment 2 of the present invention, immediately before the start of automatic parking, the error in the circumferential length of the tire is corrected by using the correction information acquired while performing autonomous traveling. Thus, the estimation of the host vehicle position by the dead reckoning during the automatic parking is improved, and the accuracy of the parking position can be improved.

### Embodiment 3

Embodiment 3 of the present invention will be described below.

In Embodiment 3, as in Embodiment 1, in a driving assistance system that performs autonomous traveling including parking by using a traveling route 310 stored in advance, information for correcting an error in a position and an orientation direction of the camera 111 is automatically acquired during the autonomous traveling, and correction processing is executed.

Embodiment 3 is different from Embodiment 1 in that the processing of extracting the section for collecting the information necessary for correcting the error of the camera 111 is executed not by the vehicle control device 100 mounted on the vehicle 200 but by a computer 1112 capable of communicating with the vehicle 200.

Hereinafter, the same components and processing as those in Embodiment 1 are denoted by the same reference signs as those in Embodiment 1, and the detailed description thereof will be omitted.

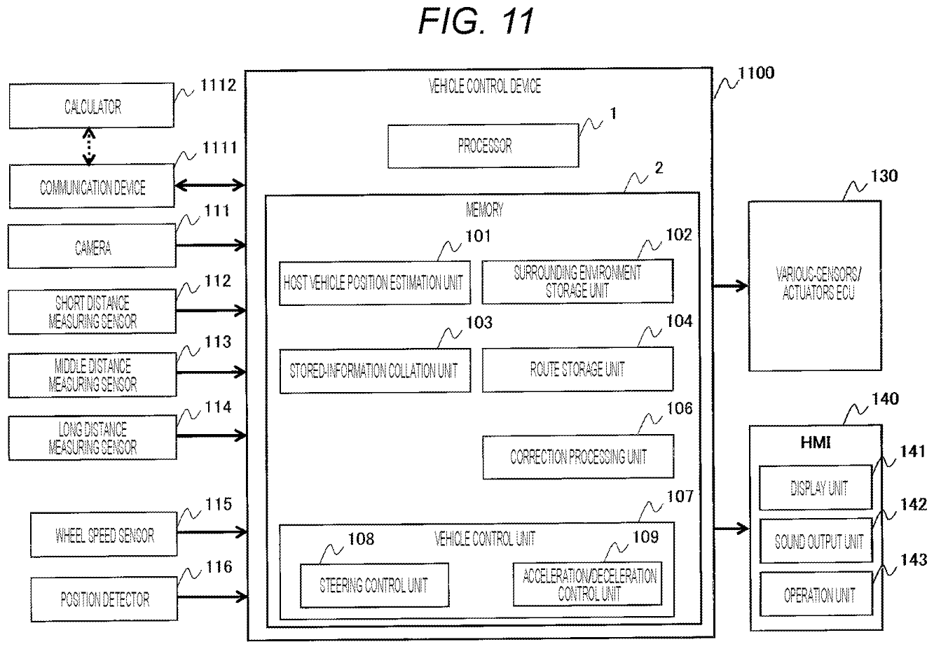

FIG. 11 is a functional block diagram illustrating the driving assistance system according to Embodiment 3 of the present invention, in which the vehicle control device 100 is replaced with a vehicle control device 1100 and a communication device 1111 is added with respect to FIG. 1.

The vehicle control device 1100 has a configuration obtained by removing the correction-information collection-section extraction unit 105 from the vehicle control device 100 described in Embodiment 1.

The communication device 1111 transmits and receives data to and from the computer 1112 outside the vehicle, which is connected via a radio communication line such as a portable phone or a radio LAN.

In the present embodiment, the processing of storing the traveling route and the route surrounding environment is the same as that in Embodiment 1, and is specifically as illustrated in the flowchart of FIG. 4.

After the processing of storing the traveling route 310 and the route surrounding environment information is completed, the vehicle control device 1100 transmits the stored traveling route 310 and route surrounding environment information to the computer 1112 via the communication device

The computer 1112 extracts a correction-information collection section by using the received traveling route and route surrounding environment information.

The processing at this time is the same as that of the correction-information collection-section extraction unit 105 in Embodiment 1, and is specifically as illustrated in the flowchart of FIG. 6.

When the extraction of the correction-information collection section is completed, the computer 1112 transmits information of the extracted correction-information collection section to the vehicle control device 1100.

The vehicle control device 1100 receives the information of the correction-information collection section via the communication device 1111 and stores the received information in the route storage unit 104.

The processing of the autonomous traveling using the stored surrounding environment information after that is the same as that in Embodiment 1.

According to Embodiment 3 of the present invention, in addition to the effect in Embodiment 1, it is possible to reduce the processing load of the vehicle control device by externally executing the processing of extracting the correction-information collection section.

### Embodiment 4

Embodiment 4 of the present invention will be described below.

In Embodiment 4, in a driving assistance system that performs autonomous traveling including passing through an electronic toll collection system (ETC) gate of an expressway by using a traveling route 310 stored in advance, information for correcting an error in the position and orientation direction of the camera 111 is automatically acquired during the autonomous traveling by the method of the present invention, and correction processing is executed.

A system configuration in Embodiment 4 of the present invention is the same as that in Example 1, but the trigger of processing of each component of the vehicle control device 100 and processing of the vehicle control unit 107 in Embodiment 4 are different from those in Embodiment 1.

Hereinafter, the same components and processing as those in Embodiment 1 are denoted by the same reference signs as those in Embodiment 1, and the detailed description thereof will be omitted.

The vehicle control device 100 according to Embodiment 4 of the present invention has three autonomous traveling modes of a normal autonomous traveling mode, a stored-route tracking autonomous traveling mode, and a low-speed autonomous traveling mode.

The normal autonomous traveling mode is a mode in which autonomous traveling is performed by using route information calculated from map information.

As described in Embodiment 1, the stored-route tracking autonomous traveling mode is a mode in which a traveling route 310 on which the vehicle has traveled by the driving of an occupant is stored in advance, and autonomous traveling is performed to track the traveling route 310.

Similarly to the stored-route tracking autonomous traveling mode, the low-speed autonomous traveling mode is a mode in which the vehicle tracks the traveling route 310 stored in advance, but, in order to pass through a road narrower than a normal traveling lane, the vehicle autonomously travels at a lower vehicle speed and with higher positional accuracy than in other modes.

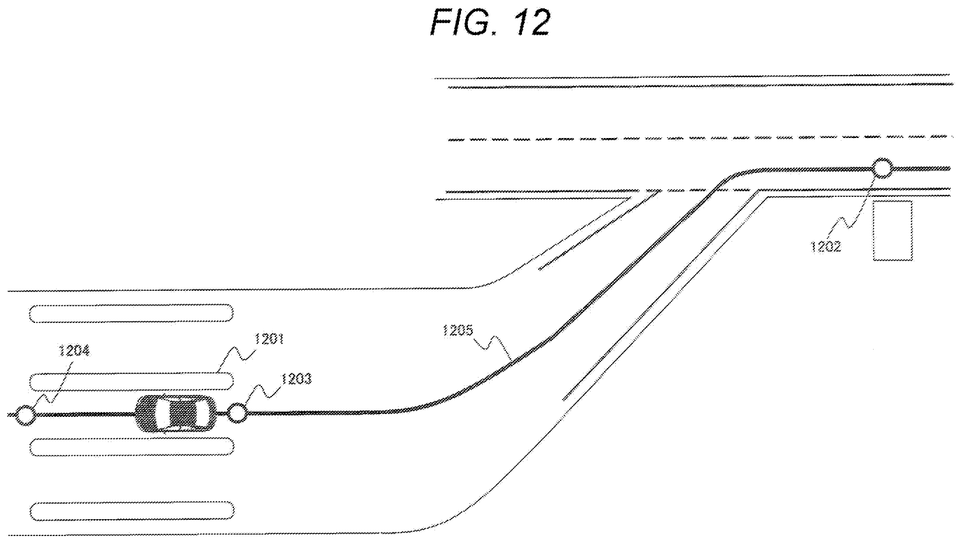

A use form assumed by the driving assistance system in Embodiment 4 of the present invention will be described with reference to FIG. 12.

FIG. 12 is a plan view in which the vehicle 200 having the present driving assistance system passes through an ETC gate 1201.

When an occupant is driving the vehicle 200, if the occupant issues an instruction to start storing of the surrounding environment information at a storing start point 1202, the vehicle control device 100 stores a subsequent traveling route 1205 of the vehicle 200 and the surrounding environment information of the traveling route 1205.

When the vehicle passes through the ETC gate 1201 by a driving operation of an occupant, if the occupant issues an instruction to store the start point position of the ETC gate 1201, the vehicle control device 100 stores the position of an ETC gate start point 1203.

Further, if the occupant issues an instruction to store the end point position of the ETC gate 1201 after the vehicle passes through the ETC gate 1201, the vehicle control device 100 stores the position of an ETC gate end point 1204.

When the vehicle 200 passes through the ETC gate 1201 by autonomous traveling next in a state where storing of the information is completed, if the vehicle reaches the storing start point 1202, the vehicle control device 100 automatically switches the mode to the stored-route tracking autonomous traveling mode, and controls the steering and the vehicle speed in accordance with the stored traveling route 1205. Thus, the vehicle 200 autonomously travels while tracking the stored traveling route 1205.

Further, if the vehicle reaches the ETC gate start point 1203 by the autonomous traveling, the vehicle control device 100 automatically switches the mode to the low-speed autonomous traveling mode and autonomously travels in the ETC gate 1201.

Then, if the vehicle reaches the ETC gate end point 1204, the vehicle control device 100 switches the mode to the normal autonomous traveling mode and continues the autonomous traveling.

In the present embodiment, the processing of storing the traveling route and the route surrounding environment is the same as that in Embodiment 1, and is specifically as illustrated in the flowchart of FIG. 4.

Processing of extracting a section for collecting correction information is the same as that in Embodiment 1, and is specifically as illustrated in the flowchart of FIG. 6.

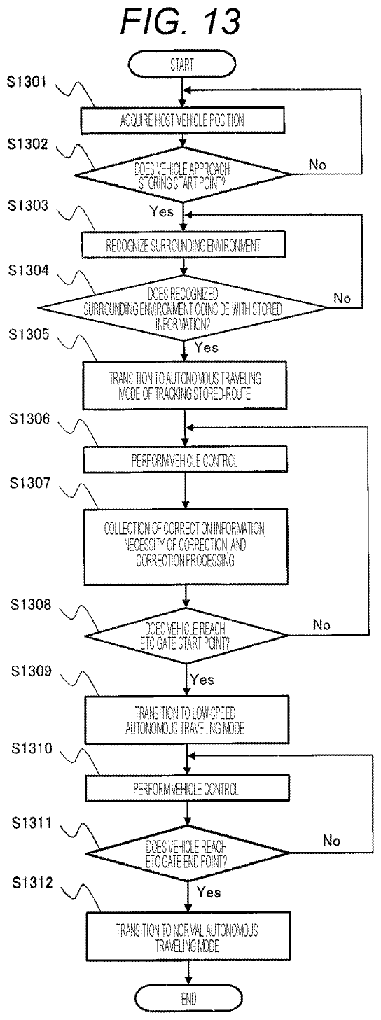

FIG. 13 is a flowchart illustrating processing executed by the vehicle control device 100 when the vehicle autonomously travels through the ETC gate 1201 by using the stored surrounding environment information.

When the vehicle 200 is traveling in the normal autonomous traveling mode in a state where the surrounding environment information and the route information are stored, the vehicle control device 100 uses the GNSS information of the position detector 116 to acquire a rough position of the host vehicle (Step S1301).

Then, the vehicle control device 100 compares the host vehicle position acquired in Step S1301 with the position of the storing start point 1202, and determines whether or not the vehicle 200 has approached the storing start point 1202 (Step S1302). When it is determined that the vehicle has not approached the storing start point 1202, the process returns to Step S1301.

When it is determined in Step S1302 that the vehicle has approached the storing start point 1202, the vehicle control device 100 recognizes the surrounding environment with the external-environment sensors (Step S1303), and causes the stored-information collation unit 103 to execute processing of collation with the surrounding environment information stored in the surrounding environment storage unit 102 (Step S1304). The specific processing of Step S1304 is the same as that of Step S704 in Embodiment 1.

When the stored-information collation unit 103 determines, in Step S1304, that the recognized surrounding environment information coincides with the surrounding environment information stored in the surrounding environment storage unit 102, the vehicle control device 100 transitions to the stored-route tracking autonomous traveling mode (Step S1305), and then performs steering and acceleration/deceleration control based on the stored traveling route 1205 (Step S1306).

In addition, the vehicle control device 100 collects correction information for the camera 111 with the transition to the stored-route tracking autonomous traveling mode as a trigger, and determines the necessity of correction. As a result, when it is determined that correction is necessary, correction processing is executed (Step S1307). The specific processing of Step S1307 is the same as that of Step S708 in Embodiment 1.

If the correction processing is completed in Step S1307, the vehicle control device 100 determines whether the vehicle 200 has reached the ETC gate start point 1203 (Step S1308).

When determining that the vehicle has not reached the ETC gate start point 1203, the vehicle control device 100 causes the process to return to Step S1306.

When it is determined in Step S1308 that the vehicle has reached the ETC gate start point 1203, the vehicle control device 100 transitions to the low-speed autonomous traveling mode (Step S1309), and performs steering and acceleration/deceleration control for low-speed traveling, based on the stored traveling route 1205 (Step S1310).

At this time, since the errors in the position and orientation direction of the camera 111 are corrected, the recognition accuracy by the camera 111 is improved.

Further, the vehicle control device 100 determines whether or not the vehicle has reached the ETC gate end point 1204 (Step S1311). When it is determined that the vehicle has reached the ETC gate end point 1204, the vehicle control device 100 transitions to the normal autonomous traveling mode (Step S1312). When it is determined that the vehicle has not reached the ETC gate end point 1204, the process returns to Step S1310.

According to Embodiment 4 of the present invention, the error in the position and orientation direction of the camera 111 is corrected by using the correction information acquired while performing the autonomous traveling, immediately before the vehicle reaches the ETC gate 1201. Thus, the recognition accuracy by the camera 111 at the time of passing through the ETC gate 1201 by the autonomous traveling is improved, and the guidance accuracy of the vehicle 200 can be improved.

### Conclusion

As described above, the vehicle control device 100 in Embodiments 1 to 4 can have the following configuration.

(1) A vehicle control method of controlling a vehicle by a vehicle control device (100) including a processor (1) and a memory (2), the vehicle control method including: a step (route storage unit 104) of storing route information up to a predetermined point by the vehicle control device (100); and a step (vehicle control unit 107) of performing autonomous traveling based on the route information by the vehicle control device (100), in which, in the step (104) of storing, a section for collecting information for disturbance correction on an external-environment sensor is stored (correction-information collection-section extraction unit 105), and, in the step (107) of performing the autonomous traveling, the disturbance correction on the external-environment sensor is performed using information collected during traveling in the section (correction processing unit 106).

With the above configuration, it is possible to minimize the accumulation of errors with traveling after correction, by performing error correction of an external-environment sensor immediately before start of automatic parking. Thus, positional accuracy when the vehicle autonomously travels, and then stops at a parking start point is improved, and this contributes to improvement of the accuracy of the final parking position.

(2) The vehicle control method described in (1), in which, in the step (107) of performing the autonomous traveling, necessity of disturbance correction of the external-environment sensor up to the predetermined point is determined based on the collected information (106), and, when it is determined that the disturbance correction is necessary, the disturbance correction of the external-environment sensor is performed by using the collected information, before the vehicle reaches the predetermined point (106).

With the above configuration, it is possible to minimize the accumulation of errors with traveling after correction, by performing error correction of an external-environment sensor immediately before start of automatic parking. Thus, positional accuracy when the vehicle autonomously travels, and then stops at a parking start point is improved, and this contributes to improvement of the accuracy of the final parking position.

(3) The vehicle control method described in (1) or (2), in which, in the step of storing, a route up to the predetermined point is stored by an operation of a driver.

With the above configuration, the vehicle control device 100 can store a route in which a vehicle travels up to a storage location through a route used on a daily basis and then stops at a target parking position 301.

(4) The vehicle control method described in any one of (1) to (3), in which, in the step (107) of performing the autonomous traveling, when the vehicle passes through a section in which the information for performing the disturbance correction is collected, the vehicle travels under a traveling condition (105, S804) suitable for collecting the information.

With the above configuration, the correction processing unit 106 commands the acceleration/deceleration control unit 109 to travel straight (steering angle is neutral) at a vehicle speed set in advance, as a traveling condition suitable for collecting information. Thus, it is possible to optimize the condition for capturing of the camera 111 (front camera 111A).

(5) The vehicle control method described in any one of (1) to (4), in which the predetermined point is a point where an occupant of the vehicle gets off.

With the above configuration, by setting a parking start point 303 as a point where the occupant of the vehicle gets off, it is possible to cause the vehicle to travel to a target parking position 301 by automatic parking.

(6) The vehicle control method described in (5), in which in the step of storing, a route from the predetermined point to a parking position being an end point is also stored, and, in the step of performing the autonomous traveling, the autonomous traveling is performed from the predetermined point to the end point, in a state where a driver is not on board.

With the above configuration, the vehicle control device 100 can store a desired parking position driven by the occupant as the target parking position 301.

(7) The vehicle control method described in any one of (1) to (4), in which the route information indicates a route (1205) passing through an ETC gate (1201), the predetermined point is a start point (1203) of the ETC gate, in the step of storing, a route (1205) from the start point (1203) to an end point (1204) of the ETC gate (1201) is also stored, and, in the step (107) of performing the autonomous traveling, the autonomous traveling is performed based on route information generated based on external environment information, after the vehicle has reached the end point (1204) of the ETC gate.

With the above configuration, the error in the position and orientation direction of the camera 111 is corrected by using the correction information acquired while performing the autonomous traveling, immediately before the vehicle reaches the ETC gate 1201. Thus, the recognition accuracy by the camera 111 at the time of passing through the ETC gate 1201 by the autonomous traveling is improved, and the guidance accuracy of the vehicle 200 can be improved.

Note that, the present invention is not limited to the above example, and various modifications may be provided.

For example, the above embodiments are described in detail in order to explain the present invention in an easy-to-understand manner, and the above embodiments are not necessarily limited to a case including all the described configurations. Further, some components in one embodiment can be replaced with the components in another embodiment, and the configuration of another embodiment can be added to the configuration of one embodiment. Further, for some of the components in the embodiments, any of addition, deletion, or replacement of other components can be applied singly or in combination.

Some or all of the configurations, functions, functional units, processing means, and the like may be realized in hardware by being designed with an integrated circuit, for example. Further, the above-described respective components, functions, and the like may be realized by software by the processor interpreting and executing a program for realizing the respective functions.

Control lines and information lines considered necessary for the descriptions are illustrated, and not all the control lines and the information lines in the product are necessarily shown. In practice, it may be considered that almost all components are connected to each other.

### Supplement

Representative aspects of the present invention other than those described in the claims include the following.

<5>

The vehicle control method according to claim 4, in which the disturbance is a change in a tire diameter or a tire circumferential length.

<6>

The vehicle control method according to claim 4, in which the disturbance is a change in an orientation direction of a camera.

<7>

The vehicle control method according to claim 4, in which, in the step of storing the route, a section for collecting information for performing the disturbance correction from external sensing results at a plurality of points is stored.

<8>

The vehicle control method according to claim 4, in which a section for collecting the information for performing the disturbance correction is a straight section having a length equal to or longer than a predetermined length, and the straight section including a road mark.

<8>

The vehicle control method according to claim 8, in which a start point position of the straight section is stored as the section for collecting information for performing the disturbance correction.

<12>

The vehicle control method according to any one of claims 1 to 11, in which a section for collecting information for performing the disturbance correction is extracted by vehicle control means mounted on the vehicle.

<13>

The vehicle control method according to any one of claims 1 to 11, in which a section for collecting the information for performing the disturbance correction is extracted by a computer that is installed in a place different from the vehicle and can communicate with the vehicle.

### REFERENCE SIGNS LIST

100 vehicle control device
101 host vehicle position estimation unit
102 surrounding environment storage unit
103 stored-information collation unit
104 route storage unit
105 correction-information collection-section extraction unit
106 correction processing unit
107 vehicle control unit
108 steering control unit
109 acceleration/deceleration control unit
111 camera
112 short distance measuring sensor
113 middle distance measuring sensor
114 long distance measuring sensor
115 wheel speed sensor
116 position detector
130 various-sensors/actuators ECU
140 HMI
141 display unit
142 sound output unit
143 operation unit
200 vehicle
201 traveling power source
202 transmission
203 wheel
204 brake device
205 power steering device
301 target parking position
302 storing start point
303 parking start point
310 route
321 utility pole
322 traffic light
323 pedestrian crossing
324 sign
325 road mark
326 white line

1. A vehicle control method for controlling a vehicle by a vehicle control device including a processor and a memory, the vehicle control method comprising:
a step of storing route information up to a predetermined point by the vehicle control device; and
a step of performing autonomous traveling based on the route information by the vehicle control device,
wherein, in the step of storing, a section for collecting information for disturbance correction on an external-environment sensor is stored, and
in the step of performing the autonomous traveling, the disturbance correction on the external-environment sensor is performed using information collected during traveling in the section.

2. The vehicle control method according to claim 1, wherein
in the step of performing the autonomous traveling,
necessity of disturbance correction of the external-environment sensor up to the predetermined point is determined based on the collected information, and
when it is determined that the disturbance correction is necessary, the disturbance correction of the external-environment sensor is performed by using the collected information, before the vehicle reaches the predetermined point.

3. The vehicle control method according to claim 1, wherein, in the step of storing, a route up to the predetermined point is stored by an operation of a driver.

4. The vehicle control method according to claim 1, wherein, in the step of performing the autonomous traveling, when the vehicle passes through a section in which the information for performing the disturbance correction is collected, the vehicle travels under a traveling condition suitable for collecting the information.

5. The vehicle control method according to claim 1, wherein the predetermined point is a point at which an occupant of the vehicle gets off.

6. The vehicle control method according to claim 5, wherein
in the step of storing, a route from the predetermined point to a parking position being an end point is also stored, and
in the step of performing the autonomous traveling, the autonomous traveling is performed from the predetermined point to the end point, in a state where a driver is not on board.

7. The vehicle control method according to claim 1, wherein
the route information indicates a route passing through an ETC gate,
the predetermined point is a start point of the ETC gate,
in the step of storing, a route from the start point to an end point of the ETC gate is also stored, and
in the step of performing the autonomous traveling, the autonomous traveling is performed based on route information generated based on external environment information, after the vehicle has reached the end point of the ETC gate.

8. A vehicle control device including a processor and a memory, the vehicle control device comprising:
a storage unit that stores route information up to a predetermined point, and stores a section for collecting information for performing disturbance correction on an external-environment sensor;
a vehicle control unit that controls a vehicle based on the route information; and
a correction processing unit that performs disturbance correction of the external-environment sensor by using information collected during traveling in the section.

9. The vehicle control device according to claim 8, further comprising:
a determination unit that determines necessity of the disturbance correction of the external-environment sensor until the vehicle reaches a predetermined point on the route of which route information is stored, based on the collected information,
wherein the correction processing unit performs the disturbance correction when the determination unit determines that the disturbance correction is necessary.

10. The vehicle control device according to claim 8, wherein the storage unit stores route information when the vehicle travels by driving of the occupant.

11. The vehicle control device according to claim 10, wherein
the vehicle control unit causes the vehicle to travel under a traveling condition suitable for collecting information, when the vehicle passes through a section in which the information for performing the disturbance correction is collected.

12. The vehicle control device according to claim 8, wherein the predetermined point is a point at which an occupant of the vehicle gets off.

13. The vehicle control device according to claim 8, wherein
the predetermined point is a parking position,
the storage unit also stores a getting-off point at which an occupant of the vehicle gets off, and
the vehicle control unit causes the vehicle to perform autonomous traveling from the getting-off point to the parking position, in a state where a driver is not on board.

14. The vehicle control device according to claim 8, wherein
the route information indicates a route passing through an ETC gate,
the predetermined point is a start point of the ETC gate,
the storage unit stores a route from the start point to an end point of the ETC gate is also stored, and
the vehicle control unit performs the autonomous traveling based on route information generated based on external environment information, after the vehicle has reached the end point of the ETC gate.
